(19) United States
(12) Patent Application Publication
(10) Pub. No.: US 2025/0161916 A1
(43) Pub. Date: May 22, 2025

(54) AMORPHOUS SILICA-ALUMINA AND METHODS OF PREPARING

(71) Applicant: Saudi Arabian Oil Company, Dhahran (SA)

(72) Inventors: Lianhui Ding, Dhahran (SA); Faisal Alotaibi, Al-Khobar (SA); Mohammad Z. Al-Bahhar, Dhahran (SA); Batool Altaher, Dhahran (SA); Mohammad F. Aljishi, Dhahran (SA)

(21) Appl. No.: 18/514,307

(22) Filed: Nov. 20, 2023

(51) Int. Cl. B01J 21/12; B01J 35/10; B01J 37/00; B01J 37/08; B01J 37/12; C01B 39/02

(52) U.S. Cl. CPC B01J 21/12; B01J 35/617; B01J 35/618; B01J 35/635; B01J 35/638; B01J 35/647; B01J 35/651; B01J 35/653; B01J 35/657; B01J 37/0018; B01J 37/009; B01J 37/08; B01J 37/12; C01B 39/026

(57) ABSTRACT

This disclosure relates to an amorphous silica-alumina catalyst with a high surface area and a high pore volume useful for hydrocracking. This disclosure also relates to a process of preparing an amorphous silica-alumina catalyst with an increased surface area and an increased pore volume.

### TECHNICAL FIELD

This document relates to an amorphous silica-alumina catalyst with a high surface area and a high pore volume useful for hydrocracking. This document also relates to a process of preparing an amorphous silica-alumina catalyst with an increased surface area and an increased pore volume.

### BACKGROUND

With the growing demand for clean fuel and petrochemicals there is an increasing need for the conversion of heavy oils. Hydrocracking is a widely used process in petroleum refining to convert heavy oil fragments into clean fuels such as diesel through the breakage of C—C bonds. This process combines catalytic cracking and hydrogenation to crack heavy feedstocks. However, current challenges with the existing catalysts for this process includes their low yield and selectivity when it comes to cracking bulky molecules. Hydrocracking is one of the most efficient processes for converting heavy oil. The catalysts used in the cracking process include crystalized zeolites (e.g., zeolite Y, beta), amorphous silica-alumina (ASA), and alumina. ASAs are a family of materials which are characterized by medium-strong tunable acidity. They were previously developed to replace previously used acid-activated bentonite clays in cracking processes starting beginning in 1942. The bentonite clays were subsequently replaced in the cracking process by synthetic protonic faujasite zeolites in the early sixties. Due to its lower acidity, better diesel selectivity, and constant diesel selectivity with time on stream (zeolite catalyst declines faster), ASA is applied to a number of hydrocracking process.

A number of different processes of preparing ASAs have been previously reported. The previously reported processes include cogelling, structure-directing agents, coprecipitation, the oil-drop method, impregnation, and grafting.

Cogelling typically includes treating solutions containing both tetravalent silicon and trivalent aluminum at acidic pH 1-3 first to produce a silica sol. A base is added to the silica sol to enhance pH to near 5-9, followed by washing and drying. See U.S. Pat. No. 6,872,685 to Timken. These materials are characterized by a bulk density near 02-0.6 g/cm³.

Structure-directing agents have been used for ASAs. In recent years, a number of materials with mesoporosity were developed at the industrial level, using structure directing agents to direct or adjust porosity. See Perego et al., Chem. Soc. Rev. 42 (2013) pages 3956-3976. The ASAs produced with this process are essentially amorphous SA with non-structural although sometimes ordered mesopores.

Coprecipitation is performed by treating solutions containing both tetravalent silicon and trivalent aluminum near neutral pH, A mixed precipitate is produced which is then washed and dried. See U.S. Pat. No. 2,735,801 to Gutzeit.

The “oil drop method” includes mixing an alumina sol and a silica sol and feeding the resulting mixture on top of a forming tower filled with circulating hot oil.

Impregnation or grafting includes impregnating or grafting of silica gel by an aluminum precursor followed by drying and calcining the resulting product.

Grafting of silica precursors includes grafting silica precursors in sufficiently large amounts onto alumina or boehmite followed by drying and calcining the resulting product.

Therefore, there is a need for a process of preparing a an amorphous silica-alumina catalyst with an increased surface area and an increased pore volume.

### SUMMARY

Provided in the present disclosure is a process of preparing an amorphous silica-alumina, the process including: reacting a zeolite with an oxidizing agent in a first solvent to form a first product; reacting a structure-directing agent with the first product to form a second product; and calcining the second product resulting in the amorphous silica-alumina.

In some embodiments, the amorphous silica-alumina has a surface area of at least 900 m²/g.

In some embodiments, the amorphous silica-alumina has a pore volume of at least 0.9 ml/g.

In some embodiments, the amorphous silica-alumina has pore sizes of at least about 4 nm.

In some embodiments, the zeolite is zeolite Y.

In some embodiments, the zeolite is CBV-720.

In some embodiments, the zeolite is CBV-760.

In some embodiments, the oxidizing agent is a hydroxide salt.

In some embodiments, the hydroxide salt is sodium hydroxide.

In some embodiments, the oxidizing agent to zeolite weight ratio is about 0.2 to about 2.

In some embodiments, the reacting the zeolite with the oxidizing agent in a first solvent comprises heating the reaction while agitating the reaction. The heating the reaction while agitating the reaction may include heating to between about 40° C. to about 80° C. and stirring the reaction between about 2 to about 8 hours.

In some embodiments, the oxidizing agent is dissolved in the first solvent, and wherein the first solvent is water.

In some embodiments, the structure-directing agent is suspended in a second solvent. The suspension may be added slowly to the first product suspended in the first solvent and agitated for between about 10 to about 24 hours. The second solvent may be water.

In some embodiments, the structure-directing agent is selected from CTAB. P123, or F127.

In some embodiments, the first solvent to zeolite weight ratio is about 20 to about 60.

In some embodiments, the second product is heated between about 60° C. to about 140° C. above atmospheric pressure for between about 10 to about 40 hours.

In some embodiments, the process includes collecting the second product. In some embodiments, the process includes collecting the second product before calcination. In some embodiments, the collecting the second product comprises filtering. The second product may be dried at between about 60° C. to about 140° C. for between about 10 to about 40 hours.

In some embodiments, the calcining the second product comprises drying at between about 100° C. to about 150° C. for between about 4 to about 24 hours.

In some embodiments, the calcining the second product comprises heating at between about 450° C. to about 550° C. for between about 2 to about 6 hours.

In some embodiments, the structure-directing agent to zeolite weight ratio is about 0.5 to about 3.

### DESCRIPTION OF DRAWINGS

FIG. 1 illustrates the proposed mechanism of formation of ASAs using the process disclosed herein.

FIG. 2 illustrates the XRD spectra of the six treated zeolite Y samples.

FIG. 3 illustrates an embodiment of the mechanism of a process for preparing amorphous silica-alumina catalysts.

### DETAILED DESCRIPTION

Therefore, there is a need for a process of preparing a an amorphous silica-alumina catalyst with a high surface area and a high pore volume. The increased surface area provides more reaction sites. Increased pore volume assists large molecule diffusion inside the catalysts. A meso-alumina catalyst prepared as described herein may have a narrower pore size distribution. A meso-alumina catalyst helps improve catalyst stability and efficiency. ASAs prepared by the processes described herein exhibit increased surface area and increased pore volume compared with conventional ASAs. Another feature is that ASA has high ratio of tetrahedra/octahedral Al species (from solid NMR).

Provided in the present disclosure is a process of preparing an amorphous silica-alumina. In some embodiments, the process includes reacting a zeolite with an oxidizing agent in a first solvent to form a first product. In some embodiments, the process includes reacting a structure-directing agent with the first product to form a second product. In some embodiments, the process includes collecting the second product. In some embodiments, the process includes calcining the second product resulting in the amorphous silica-alumina.

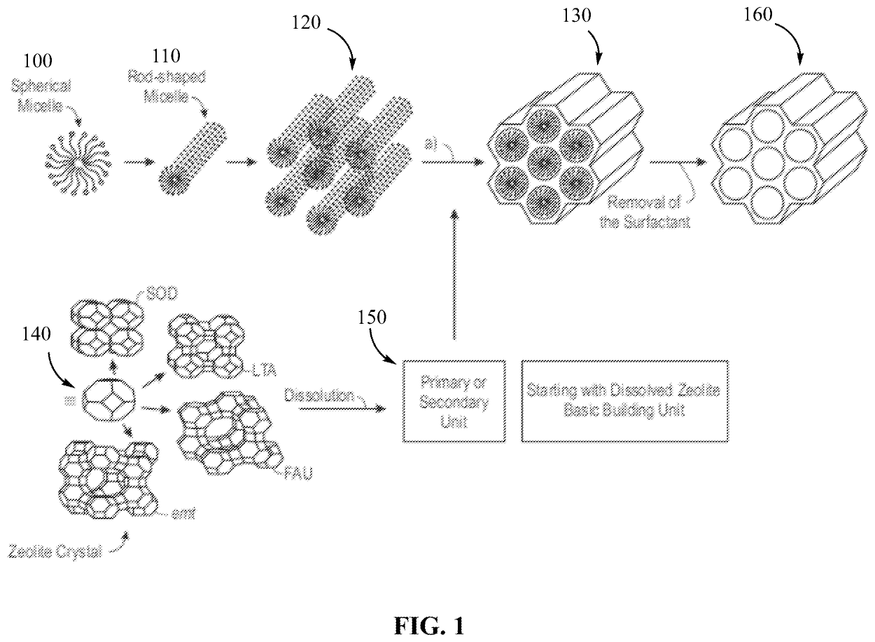

Different from above mentioned methods (mainly bottom-up method), the processes described herein develops an improved method to synthesis ASA. Bottom-up methods typically start with silica and aluminum sources which are coprecipitated to prepare the ASA. The processes described herein can be described as a top-down method or process. In some embodiments, top-down processes include treating a zeolite with a high silica to aluminum molar ratio is treated with a basic solution. Treating the zeolite with a basic solution or oxidizing agent may break down the zeolite to amorphous silica-alumina containing small zeolite building units. A silica to aluminum (SiO₂/Al₂O₃) molar ratio for a zeolite may include a molar ratio greater than 20. The primary or second building units created by breaking down the zeolite may be assembled around structure-defining agents. In some embodiments, the structure-defining agents form micelles around which the zeolite building units assemble in solution. An example of a structure-defining agent is Cetyltrimethylammonium bromide (CTAB). A proposed mechanism of the disclosed process is illustrated in FIG. 1. In the embodiment depicted in FIG. 1 micelles (100) formed by structure-defining agents can form rod-shaped micelles (110) in solution. The rod-shaped micelles (110) can further organize relative to each other (120). The broken down zeolite building units self-assemble (130) around the micelles to form improved ASAs.

In some embodiments, the amorphous silica-alumina has a surface area of at least 900 m²/g. In some embodiments, the amorphous silica-alumina has a surface area of at least about 900 m²/g. In some embodiments, the amorphous silica-alumina has a surface area of at least 1000 m²/g. In some embodiments, the amorphous silica-alumina has a surface area of at least about 1000 m²/g. In some embodiments, the amorphous silica-alumina has a surface area of at least 1100 m²/g. In some embodiments, the amorphous silica-alumina has a surface area of at least about 1100 m²/g. In some embodiments, the amorphous silica-alumina has a surface area of at least 1200 m²/g. In some embodiments, the amorphous silica-alumina has a surface area of at least about 1200 m²/g.

In some embodiments, the amorphous silica-alumina has a pore volume of at least 0.9 ml/g. In some embodiments, the amorphous silica-alumina has a pore volume of at least about 0.9 ml/g. In some embodiments, the amorphous silica-alumina has a pore volume of at least 1.0 ml/g. In some embodiments, the amorphous silica-alumina has a pore volume of at least about 1.0 ml/g. In some embodiments, the amorphous silica-alumina has a pore volume of at least 1.2 ml/g. In some embodiments, the amorphous silica-alumina has a pore volume of at least about 1.2 ml/g.

In some embodiments, the amorphous silica-alumina has pore sizes of at least 4 nm. In some embodiments, the amorphous silica-alumina has pore sizes of at least about 4 nm. In some embodiments, the amorphous silica-alumina has pore sizes of at least 5 nm. In some embodiments, the amorphous silica-alumina has pore sizes of at least about 5 nm. In some embodiments, the amorphous silica-alumina has pore sizes of at least 6 nm. In some embodiments, the amorphous silica-alumina has pore sizes of at least about 6 nm. In some embodiments, the amorphous silica-alumina has pore sizes of at least 9 nm. In some embodiments, the amorphous silica-alumina has pore sizes of at least about 9 nm.

By introducing mesopores (active sites) in the ASA which increases the pore volume (e.g., more than 0.9 ml/g and surface area to higher than 900 m²/g) the selectivity and yield of diesel through the hydrocracking process is enhanced.

In some embodiments, the zeolite is zeolite Y. In some embodiments, the zeolite is CBV-720. In some embodiments, the zeolite is CBV-760.

In some embodiments, the hydroxide salt is sodium hydroxide. In some embodiments, the oxidizing agent to zeolite weight ratio is about 0.5 to about 1.5. In some embodiments, the hydroxide salt is sodium hydroxide. In some embodiments, the oxidizing agent to zeolite weight ratio is about 0.2 to about 2. In some embodiments, the oxidizing agent to zeolite weight ratio is about 0.1 to about 4.

In some embodiments, the reacting the zeolite (140 of FIG. 1) with the oxidizing agent in a first solvent comprises heating the reaction while agitating the reaction. Treating the zeolite with is a basic solution may break down the zeolite (140) to amorphous silica-alumina containing small zeolite building units (150). The heating the reaction while agitating the reaction may include heating to between about 40° C. to about 80° C. The heating the reaction while agitating the reaction may include heating to between about 30° C. to about 90° C. Agitating the reaction may include stirring the reaction. The reaction may be agitated for between about 2 hours to about 8 hours. The reaction may be agitated for at least about 2 hours.

In some embodiments, the oxidizing agent is dissolved in the first solvent, and wherein the first solvent is water.

In some embodiments, the structure-directing agent is suspended in a second solvent. The suspension may be added slowly to the first product suspended in the first solvent and agitated for at least about 2 hours. The suspension may be added slowly to the first product suspended in the first solvent and agitated for at least about 6 hours. The suspension may be added slowly to the first product suspended in the first solvent and agitated for at least about 8 hours. The suspension may be added slowly to the first product suspended in the first solvent and agitated for between about 10 to about 24 hours. The second solvent may be water. Slow addition of the suspension may include dropwise addition of the suspension/solution. The broken down zeolite building units self-assemble (130) around the micelles to form improved ASAs.

In some embodiments, the structure-directing agent is selected from CTAB. P123, or F127.

In some embodiments, the structure-directing agent to zeolite weight ratio is 0.5 to 3. In some embodiments, the structure-directing agent to zeolite weight ratio is about 0.5 to about 3. In some embodiments, the structure-directing agent to zeolite weight ratio is at least 0.5. In some embodiments, the structure-directing agent to zeolite weight ratio is at least 1.0. In some embodiments, the structure-directing agent to zeolite weight ratio is at least 1.5.

In some embodiments, the first solvent to zeolite weight ratio is 20 to 60. In some embodiments, the first solvent to zeolite weight ratio is about 20 to about 60. In some embodiments, the first solvent to zeolite weight ratio is 10 to 80. In some embodiments, the first solvent to zeolite weight ratio is about 10 to about 80.

In some embodiments, the second product is heated at least about 60° C. for at least about 8 hours. In some embodiments, the second product is heated at least about 40° C. for at least about 4 hours. In some embodiments, the second product is heated between about 60° C. to about 140° C. for between about 10 to about 40 hours. In some embodiments, the second product is heated between about 60° C. to about 140° C. above atmospheric pressure for between about 10 to about 40 hours. The second product may be heated in an autoclave about atmospheric pressure.

In some embodiments, the process includes collecting the second product. In some embodiments, the collecting the second product comprises filtering the second product from a suspension. The collected second product may be washed. The collected second product may be washed multiple times (e.g., about 2 to about 4 times). The collected second product may be dried. The collected second product may be dried at an elevated temperature at between about 100° C. to about 150° C. The collected second product may be dried for at least four hours. The collected second product may be dried for at least about four hours. The collected second product may be dried for between about 4 hours to about 24 hours.

In some embodiments, the process includes calcining the second product resulting in the amorphous silica-alumina (160). In some embodiments, the calcining the second product comprises heating at least about 400° C. In some embodiments, the calcining the second product comprises heating at between 450° C. to 550° C. In some embodiments, the calcining the second product comprises heating at between about 450° C. to about 550° C. The dried collected product may be heated at an elevated temperature to achieved calcination for at least about 2 hours. The dried collected product may be heated at an elevated temperature to achieved calcination for between 2 to 6 hours. The dried collected product may be heated at an elevated temperature to achieved calcination for between about 2 to about 6 hours. In some embodiments, the calcining the second product comprises heating at between about 450° C. to about 550° C. for between about 2 to about 6 hours. Calcining the second product may result in removal of impurities including the structure-directing agents from the formed ASA (see 160 of FIG. 1).

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range. The term “about,” as used in this disclosure, can allow for a degree of variability in a value or range of within 10% of a stated value or of a stated limit of a range.

As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

“Calcination”, as used herein, refers to a process of heating a substance to a high temperature but typically below the melting or fusing point, causing loss of moisture or impurities, reduction or oxidation, and/or dissociation into simpler substances.

“Structure-directing agent”, as used herein, refers to chemicals which help in the formation of particular channels and pores during the synthesis of, for example, zeolites. Zeolites have varied applications including as catalysts and adsorbents.

“Zeolite”, as used herein, is generally defined as a microporous, crystalline aluminosilicate material. They mainly consist of silicon, aluminum, oxygen, and have the general formula. Zeolites are commonly used as commercial adsorbents and catalysts.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results. To determine the appropriate zeolites that can produce ASA with the desired properties, six commercialized zeolite Y from Zeolyst were studied. The six zeolite Y were treated with a NaOH solution in the presence of CTAB functioning as the structure-defining agent. The six zeolite Ys have different Si/Al molar ratio, Na₂O content, and unit cell size, and thus demonstrate different stability for base treatment. The main properties of the six initial zeolites and resulting treated zeolites are summarized in TABLE 1. Five different samples were synthesized from commercial Y-zeolite (CBV-100, CBV-300, CBV-400, CBV-500, CBV-720, CBV-760). The treatment procedures for the 6 zeolites are shown below.

### Example 1: DZ-128 Starting with CBV-100 (Reference)

1) 3.37 g of CBV-100 was added into a beaker, added 30 ml 0.5M of NaOH solution, stirred at 60° C. for 4 h.
2) In another beaker, added 5 g of CTAB and 45 ml of H₂O, stirred at room temperature for 4 h.
3) Added solution (2) dropwise into (1), and stirred at room temperature for 24 h.
4) The mixture was transferred into an autoclave and heated at 100° C. for 48 h.
5) The white precipitate from the autoclave was filtered and washed twice. Between each wash, the cake was blended with 150-200 ml of H₂O, and stirred for 30 min.
6) The filtered cake was dried at 110° C. overnight, and calcinated at 600° C. for 4 h (heating rate: 2° C./min).

### Example 2: DZ-124 Staring with CBV-300 (Reference)

1) 2.76 g of CBV-300 was added into a beaker, added 30 ml 0.5M of NaOH solution, stirred at 60° C. for 4 h.
2) In another beaker, added 5 g of CTAB and 45 ml of H₂O, stirred at room temperature for 4 h.
3) Added solution (2) dropwise into (1), and stirred at room temperature for 24 h.
4) The mixture was transferred into an autoclave and heated at 100° C. for 48 h.
5) The white precipitate from the autoclave was filtered and washed twice. Between each wash, the cake was blended with 150-200 ml of H₂O, and stirred for 30 min.
6) The filtered cake was dried at 110° C. overnight, and calcinated at 600° C. for 4 h (heating rate: 2° C./min).

### Example 3: DZ-125 Starting with CBV-400 (Reference)

1) 2.71 g of CBV-400 was added into a beaker, added 30 ml 0.5M of NaOH solution, stirred at 60° C. for 4 h.
2) In another beaker, added 5 g of CTAB and 45 ml of H₂O, stirred at room temperature for 4 h.
3) Added solution (2) dropwise into (1), and stirred at room temperature for 24 h.
4) The mixture was transferred into an autoclave and heated at 100° C. for 48 h.
5) The white precipitate from the autoclave was filtered and washed twice. Between each wash, the cake was blended with 150-200 ml of H₂O, and stirred for 30 min.
6) The filtered cake was dried at 110° C. overnight, and calcinated at 600° C. for 4 h (heating rate: 2° C./min).

### Example 4: DZ-126 Starting with CBV-500 (Reference)

1) 3.35 g of CBV-500 was added into a beaker, added 30 ml 0.5M of NaOH solution, stir at 60° C. for 4 h.
2) In another beaker, added 5 g of CTAB and 45 ml of H₂O, stir at room temperature for 4 h.
3) Added solution (2) dropwise into (1), and stirred at room temperature for 24 h.
4) The mixture was transferred into an autoclave and heated at 100° C. for 48 h.
5) The white precipitate from the autoclave was filtered and washed twice. Between each wash, the cake was blended with 150-200 ml of H₂O, and stirred for 30 min.
6) The filtered cake was dried at 110° C. overnight, and calcinated at 600° C. for 4 h (heating rate: 2° C./min).

### Example 5: DZ-127 Starting with CBV-720 (Process Disclosed Herein)

1) 2.87 g of CBV-720 was added into a beaker, added 30 ml 0.5M of NaOH solution, stir at 60° C. for 4 h.
2) In another beaker, added 5 g of CTAB and 45 ml of H₂O, stirred at room temperature for 4 h.
3) Added solution (2) dropwise into (1), and stirred at room temperature for 24 h.
4) The mixture was transferred into an autoclave and heated at 100° C. for 48 h.
5) The white precipitate from the autoclave was filtered and washed twice. Between each wash, the cake was blended with 150-200 ml of H₂O, and stir for 30 min.
6) The filtered cake was dried at 110° C. overnight, and calcinated at 600° C. for 4 h (heating rate: 2° C./min).

### Example 6: DZ-6 Starting with CBV-760 (Process Disclosed Herein)

1) 2.84 g of CBV-760 was added into a beaker, added 30 ml 0.5M of NaOH solution, stir at 60° C. for 4 h.
2) In another beaker, added 5 g of CTAB and 45 ml of H₂O, stirred at room temperature for 4 h.
3) Added solution (2) dropwise into (1), and stirred at room temperature for 24 h.
4) The mixture was transferred into an autoclave and heated at 100° C. for 48 h.
5) The white precipitated from the autoclave was filtered and washed twice. Between each wash, the cake was blended with 150-200 ml of H₂O, and stir for 30 min.
6) The filtered cake was dried at 110° C. overnight, and calcinated at 600° C. for 4 h (heating rate: 2° C./min).

TABLE 1

| | Sample | | | | | |
|---|---|---|---|---|---|---|
| | DZ-128 | DZ-124 | DZ-125 | DZ-126 | DZ-127 | DZ-6 |
| | Initial zeolite | | | | | |
| | CBV-100 | CBV-300 | CBV-400 | CBV-500 | CBV-720 | CBV-760 |
| SiO₂/Al₂O₃ molar ratio | 5.1 | 5.1 | 5.1 | 5.2 | 30 | 60 |
| Na₂O, wt % | 13 | 2.8 | 2.8 | 0.2 | 0.03 | 0.03 |
| Unit cell, A | 24.65 | 24.68 | 24.5 | 24.53 | 24.28 | 24.24 |
| Before NaOH treatment | | | | | | |
| Total surface area, m²/g | 470 | 633 | 569 | 590 | 404 | 422 |
| Micropore | 433 | 563 | 499 | 520 | 223 | 250 |
| Mesopore | 37 | 70 | 70 | 70 | 181 | 172 |
| Total pore volume, ml/g | 0.3 | 0.37 | 0.36 | 0.42 | 0.47 | 0.47 |
| Micropore | 0.26 | 0.29 | 0.25 | 0.26 | 0.13 | 0.13 |
| Mesopore | 0.04 | 0.08 | 0.12 | 0.15 | 0.34 | 0.34 |
| Average Pore size, nm | 2.3 | 2.32 | 2.56 | 28.2 | 46.5 | 44.6 |
| After NaOH treatment | | | | | | |
| Crystallinity % | 99 | 101 | 99 | 100 | Amorphous | Amorphous |
| (to CBV-100) | | | | | | |
| Total surface area, m²/g | 578 | 609 | 532 | 535 | 984 | 1130 |
| Micropore | 519 | 534 | 463 | 473 | 0 | 645 |
| Mesopore | 59 | 74 | 68 | 62 | 984 | 485 |
| Total pore volume, ml/g | 0.35 | 0.39 | 0.35 | 0.36 | 0.93 | 1.21 |
| Micropore | 0.29 | 0.3 | 0.26 | 0.26 | 0 | 0.44 |
| Mesopore | 0.07 | 0.09 | 0.09 | 0.1 | 0.93 | 0.77 |
| Average Pore size, nm | 2.45 | 2.57 | 2.62 | 2.73 | 3.77 | 4.3 |

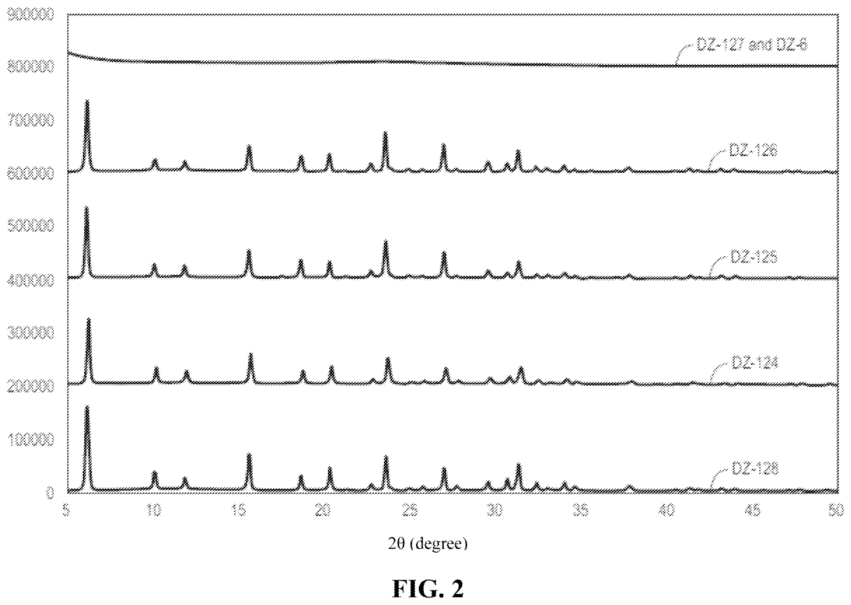

The XRD spectra of the six treated samples are shown in the FIG. 2. From the XRD results, it can be concluded that, when the SiO₂/Al₂O₃ ratio reaches a certain level, the zeolite structure was destroyed and the destructed silica-alumina can be assembled around structure defining agents (e.g., CTAB micelles) to form higher surface area and pore volume ASAs.

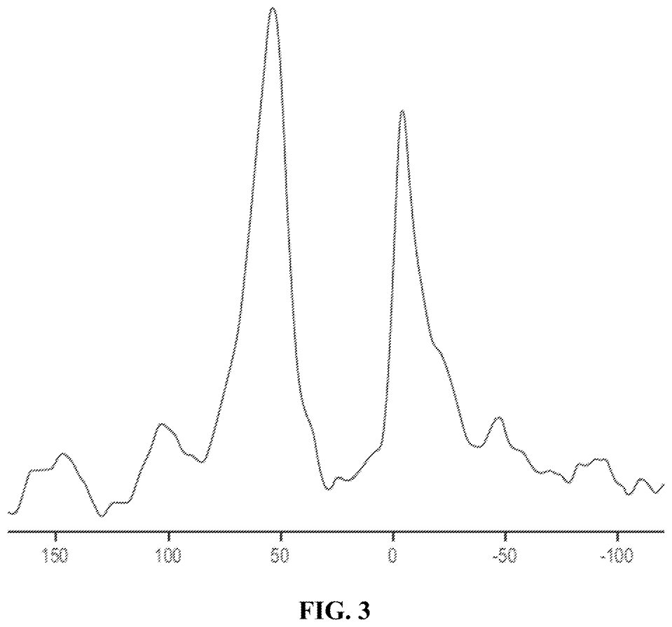

Although DZ-6 showed an amorphous phase from XRD analysis, 27Al NMR results (depicted in FIG. 3) indicated a considerable amount Al species in the final product. The Al species in the final product appear to be in a tetrahedral state which prove the existence of small zeolite building blocks.

To compare ASA prepared as described herein with commercialized ASA, the main properties of the commercialized ASA from Sasol (derived from SIRAL and SIRALOX (sasol.com)) is shown in Table 2. Sasol ASA has the best textural properties compared with other vendors.

TABLE 2

| Typical chemical and | | | SIRAL | SIRAL | SIRAL | SIRAL | SIRAL | SIRAL |
|---|---|---|---|---|---|---|---|---|
| physical properties | SIRAL 1 | SIRAL 5 | 10 | 20 | 30 | 40 | 40 HPV | 70 |
| Al₂O₃/SiO₂ [%] | 99/1 | 95/5 | 90/10 | 80/20 | 70/30 | 60/40 | 60/40 | 30/70 |
| LOI [%] | 25 | 25 | 25 | 25 | 20 | 20 | 20 | 25 |
| Loose bulk density [g/l] | 600-800 | 450-650 | 400-600 | 300-500 | 250-450 | 250-450 | 100-300 | 400-600 |
| Particle size (d50) [g/l] | 35 | 35 | 35 | 35 | 35 | 35 | 35 | 35 |
| Surface area | 280 | 350 | 370 | 420 | 380 | 480 | 500 | 450 |
| (BET)* [m²/g] | | | | | | | | |
| Pore volume* [ml/g] | 0.5 | 0.7 | 0.75 | 0.8 | 0.9 | 1.0 | 1.5 | 0.3 |

ASA prepared by the processes described herein has a higher surface area than Sasol ASA (Siral-40 HPV) (1130 vs 500 m²/g) and comparable pore volume.

### Embodiments

An embodiment is provided of a process of preparing an amorphous silica-alumina, the process comprising: reacting a zeolite with an oxidizing agent in a first solvent to form a first product; reacting a structure-directing agent with the first product to form a second product; and calcining the second product resulting in the amorphous silica-alumina.

The process of the above embodiment, wherein the amorphous silica-alumina has a surface area of at least 900 m²/g.

The process of any of the above embodiments, wherein the amorphous silica-alumina has a pore volume of at least 0.9 ml/g.

The process of any of the above embodiments, wherein the amorphous silica-alumina has pore sizes of at least about 4 nm.

The process of any of the above embodiments, wherein the zeolite is zeolite Y.

The process of any of the above embodiments, wherein the zeolite is CBV-720.

The process of any of the above embodiments, wherein the zeolite is CBV-760.

The process of any of the above embodiments, wherein the oxidizing agent is a hydroxide salt.

The process of the above embodiment, wherein the hydroxide salt is sodium hydroxide.

The process of any of the above embodiments, wherein the oxidizing agent to zeolite weight ratio is about 0.2 to about 2.

The process of any of the above embodiments, wherein the reacting the zeolite with the oxidizing agent in a first solvent comprises heating the reaction while agitating the reaction.

The process of the above embodiment, wherein the heating the reaction while agitating the reaction comprises heating to between about 40° C. to about 80° C. and stirring the reaction between about 2 to about 8 hours.

The process of any of the above embodiments, wherein the oxidizing agent is dissolved in the first solvent, and wherein the first solvent is water.

The process of any of the above embodiments, wherein the structure-directing agent is suspended in a second solvent.

The process of the above embodiment, wherein the suspension is added slowly to the first product suspended in the first solvent and agitated for between about 10 to about 24 hours.

The process of the above embodiment, wherein the second solvent is water.

The process of any of the above embodiments, wherein the structure-directing agent is selected from CTAB. P123, or F127.

The process of any of the above embodiments, wherein the first solvent to zeolite weight ratio is about 20 to about 60.

The process of any of the above embodiments, wherein the second product is heated between about 60° C. to about 140° C. above atmospheric pressure for between about 10 to about 40 hours.

The process of any of the above embodiments, further comprising collecting the second product.

The process of any of the above embodiments, wherein the collecting the second product comprises filtering.

The process of the above embodiment, wherein the second product is dried at between about 60° C. to about 140° C. for between about 10 to about 40 hours.

The process of any of the above embodiments, wherein the calcining the second product comprises drying at between about 100° C. to about 150° C. for between about 4 to about 24 hours.

The process of any of the above embodiments, wherein the calcining the second product comprises heating at between about 450° C. to about 550° C. for between about 2 to about 6 hours.

The process of any of the above embodiments, wherein the structure-directing agent to zeolite weight ratio is about 0.5 to about 3.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A process of preparing an amorphous silica-alumina, the process comprising:
Reacting a zeolite with an oxidizing agent in a first solvent to form a first product;
reacting a structure-directing agent with the first product to form a second product; and
calcining the second product resulting in the amorphous silica-alumina.

2. The process of claim 1, wherein the amorphous silica-alumina has a surface area of at least 900 m²/g.

3. The process of claim 1, wherein the amorphous silica-alumina has a pore volume of at least 0.9 ml/g.

4. The process of claim 1, wherein the amorphous silica-alumina has pore sizes of at least about 4 nm.

5. The process of claim 1, wherein the zeolite is zeolite Y.

6. The process of claim 1, wherein the zeolite is CBV-720.

7. The process of claim 1, wherein the zeolite is CBV-760.

8. The process of claim 1, wherein the oxidizing agent is a hydroxide salt.

9. The process of claim 8, wherein the hydroxide salt is sodium hydroxide.

10. The process of claim 1, wherein the oxidizing agent to zeolite weight ratio is about 0.2 to about 2.

11. The process of claim 1, wherein the reacting the zeolite with the oxidizing agent in a first solvent comprises heating the reaction while agitating the reaction.

12. The process of claim 11, wherein the heating the reaction while agitating the reaction comprises heating to between about 40° C. to about 80° C. and stirring the reaction between about 2 to about 8 hours.

13. The process of claim 1, wherein the oxidizing agent is dissolved in the first solvent, and wherein the first solvent is water.

14. The process of claim 1, wherein the structure-directing agent is suspended in a second solvent.

15. The process of claim 14, wherein the suspension is added slowly to the first product suspended in the first solvent and agitated for between about 10 to about 24 hours.

16. The process of claim 14, wherein the second solvent is water.

17. The process of claim 1, wherein the structure-directing agent is selected from CTAB. P123, or F127.

18. The process of claim 1, wherein the first solvent to zeolite weight ratio is about 20 to about 60.

19. The process of claim 1, wherein the second product is heated between about 60° C. to about 140° C. above atmospheric pressure for between about 10 to about 40 hours.

20. The process of claim 1, further comprising collecting the second product.

21. The process of claim 20, wherein the collecting the second product comprises filtering.

22. The process of claim 21, wherein the second product is dried at between about 60° C. to about 140° C. for between about 10 to about 40 hours.

23. The process of claim 1, wherein the calcining the second product comprises drying at between about 100° C. to about 150° C. for between about 4 to about 24 hours.

24. The process of claim 1, wherein the calcining the second product comprises heating at between about 450° C. to about 550° C. for between about 2 to about 6 hours.

25. The process of claim 1, wherein the structure-directing agent to zeolite weight ratio is about 0.5 to about 3.
